(19) United States
(12) Patent Application Publication
(10) Pub. No.: US 2023/0302492 A1
(43) Pub. Date: Sep. 28, 2023

(54) COATING METHOD AND COATING SYSTEM

(71) Applicant: HONDA MOTOR CO., LTD., Tokyo (JP)

(72) Inventors: Takanori HASHIMOTO, Tokyo (JP); Masaki SHIGEKURA, Tokyo (JP)

(21) Appl. No.: 18/167,094

(22) Filed: Feb. 10, 2023

(30) Foreign Application Priority Data
Mar. 22, 2022 (CN) 202210287165.6

(51) Int. Cl. B05D 7/00; B05D 3/04

(52) U.S. Cl. CPC B05D 7/534; B05D 3/0413

(57) ABSTRACT

A coating method is provided which includes the steps of applying a base paint on a workpiece, blowing air at 19° C. or higher and 26° C. or lower to the applied base paint to pre-dry the base paint, applying a clear coating on the pre-dried base paint, and finally drying the workpiece with the clear coating applied thereon.

This application is based on and claims the benefit of priority from Chinese Patent Application CN202210287165.6, filed on 22 Mar. 2022, the content of which is incorporated herein by reference.

### BACKGROUND OF THE INVENTION

### Field of the Invention

The present invention relates to a coating method and a coating system.

### Related Art

In recent years, research and development efforts have been made to contribute to energy efficiency in order to ensure access to affordable, reliable, sustainable, and advanced energy for more people.

Japanese Patent No. 2500917 describes a method of coating an automotive body with a base paint and a clear coating. The body coated with the base paint and the clear coating is dried at normal temperature for a predetermined time in a setting zone and then passes through a pre-drying zone. A drying temperature in the pre-drying zone is higher than the normal temperature and is equal to or lower than a drying temperature (baking temperature) in a final or main drying zone.
Patent Document 1: Japanese Patent No. 2500917

### SUMMARY OF THE INVENTION

However, since the automotive body is heated in the pre-drying zone, energy consumption is increased.

It is an object of the present invention to provide a coating method and a coating system that can reduce energy consumption.

According to an aspect of the present invention, a coating method includes the steps of applying a base paint on a workpiece, blowing air at 19° C. or higher and 26° C. or lower to substantially a whole area of the applied base paint to pre-dry the base paint, applying a clear coating on the pre-dried base paint, and finally drying the workpiece with the clear coating applied thereon.

The speed of the air may be 3 m/s or more and 7 m/s or less, and the time during which the air is blown to substantially the whole area of the applied base paint may be 10 minutes or more and 15 minutes or less.

The base paint may contain an organic solvent with a V value of 49 or more.

According to another aspect of the present invention, a coating system includes a first coating zone that applies a base paint on a workpiece, a pre-drying zone that blows air at 19° C. or higher and 26° C. or lower to substantially a whole area of the applied base paint to pre-dry the base paint, a second coating zone that applies a clear coating on the pre-dried base paint, and a final drying zone that finally dries the workpiece with the clear coating applied thereon.

The pre-drying zone may have a slit-like outlet through which the air is blown from around the workpiece to the applied base paint.

According to the present invention, a coating method and a coating system that can reduce energy consumption can be provided.

### BRIEF DESCRIPTION OF THE DRAWINGS

FIG. 1 shows an example of a coating system according to the present embodiment; and

FIG. 2 shows a cross-section of a pre-drying zone shown in FIG. 1.

### DETAILED DESCRIPTION OF THE INVENTION

An embodiment of the present invention is described below with reference to the drawings.

A coating method of the present embodiment includes the steps of applying a base paint on a workpiece, blowing air at 19° C. or higher and 26° C. or lower to almost or substantially the whole area of the applied base paint to pre-dry the base paint, applying a clear coating on the pre-dried base paint, and finally or mainly drying the workpiece with the clear coating applied thereon. The coating method of the present embodiment does not perform heating in pre-drying of the base paint. Therefore, energy consumption is reduced.

The workpiece is not particularly limited, and an example thereof is an automobile body.

The base paint is not particularly limited, and a known aqueous base paint can be used, for example.

A resin component contained in the aqueous base paint is not particularly limited, and examples thereof include an aqueous acrylic resin, an acrylic resin emulsion, an aqueous polyester resin, an aqueous urethane resin, an aqueous melamine resin, and an aqueous blocked isocyanate resin.

A pigment contained in the aqueous base paint is not particularly limited, and an example thereof is aluminum paste.

An additive contained in the aqueous base paint is not particularly limited, and examples thereof include an ultraviolet absorber, an antifoaming agent, a surfactant, a rheology control agent, a dispersant, and an amine.

An organic solvent contained in the aqueous base paint is not particularly limited, and examples thereof include alcohols and esters.

The base paint may be one-pack type or two-pack type.

The base paint preferably contains an organic solvent with a V value of 49 or more. When the base paint contains the organic solvent with a V value of 49 or more, the residual amount of the solvent after pre-drying is reduced, and a bright material is prevented from easily moving. Therefore, occurrence of the unevenness after pre-drying, occurrence of popping after final drying, and color difference are suppressed.

Here, the V value of an organic solvent is a specific evaporation rate when the evaporation rate of butyl acetate is assumed as 100.

The organic solvent with a V value of 49 or more is not particularly limited, and examples thereof include alcohols such as n-butyl alcohol (V value=49), isobutyl alcohol (V value=83), n-propyl alcohol (V value=100), isopropyl alcohol (V value=205), ethyl alcohol (V value=203), and methyl alcohol (V value=370). Among them, n-butyl alcohol is preferable because of its high flash point.

The coating method of the base paint is not particularly limited, and examples thereof include spray coating, rotary atomization coating, and inkjet coating.

When the base paint is applied, two or more types of base paints may be applied. In this case, pre-drying may be performed after every application of the base paint. However, it is preferable to pre-dry the two or more base paints after they are applied to be stacked. At least one of the two or more types of base paints preferably contains the organic solvent with a V value of 49 or more.

The temperature of the air blown to substantially the whole area of the applied base paint is 19° C. or higher and 26° C. or lower, and is preferably 22° C. or higher and 24° C. or lower. When the temperature of the air blown to substantially the whole area of the applied base paint is lower than 19° C., the residual amount of the organic solvent after pre-drying is increased. When that temperature exceeds 26° C., an effect of reducing energy consumption is deteriorated.

The speed of the air blown to substantially the whole area of the applied base paint is preferably 3 m/s or more and 7 m/s or less, and more preferably 4 m/s or more and 6 m/s or less. When the speed of the air blown to substantially the whole area of the applied base paint is 3 m/s or more, the residual amount of the organic solvent after pre-drying is reduced. When that speed is 7 m/s or less, adhesion of foreign matter is suppressed.

The time during which the air is blown to substantially the whole area of the applied base paint is preferably 10 minutes or more and 15 minutes or less, and more preferably 10 minutes or more and 11 minutes or less. When the time during which the air is blown to substantially the whole area of the applied base paint is 10 minutes or more, the residual amount of the organic solvent after pre-drying is reduced. When that time is 15 minutes or less, the length of a line in the pre-drying zone is shortened.

Prior to pre-drying of the workpiece with the base paint applied thereon, setting may be performed, as necessary.

Setting conditions for the workpiece with the base paint applied thereon are not particularly limited, and are 20° C. or higher and 30° C. or lower and 5 minutes or more and 15 minutes or less, for example.

The clear coating is not particularly limited, and a known solvent-based clear coating can be used, for example.

A resin component contained in the solvent-based clear coating is not particularly limited, and examples thereof include an acrylic resin and an HMDI-based isocyanurate prepolymer.

An additive contained in the solvent-based clear coating is not particularly limited, and examples thereof include a UV agent, a light stabilizer, a surface conditioner, an anti-sagging agent, a curing accelerator, and a rheology control agent.

An organic solvent contained in the solvent-based clear coating is not particularly limited, and examples thereof include aromatic solvents, alcohols, esters, ketones, petroleum solvents, and hydrocarbons.

The clear coating may be one-pack type or two-pack type.

The coating method of the clear coating is not particularly limited, and examples thereof include spray coating, rotary atomization coating, and inkjet coating.

The method of finally drying the workpiece with the clear coating applied thereon is not particularly limited, and an example of the method is heat drying (baking drying).

Heat drying conditions for the workpiece with the clear coating applied thereon are not particularly limited, and 80° C. or higher and 100° C. or lower and 15 minutes or more and 60 minutes or less, for example.

A coating system of the present embodiment includes a first coating zone that applies a base paint on a workpiece, a pre-drying zone that blows air at 19° C. or higher and 26° C. or lower to substantially the whole area of the applied base paint to pre-dry the base paint, a second coating zone that applies a clear coating on the pre-dried base paint, and a final drying zone that finally dries the workpiece with the clear coating applied thereon. Therefore, the coating method of the present embodiment can be carried out by the coating system of the present embodiment.

The coating system of the present embodiment may further include a setting zone that performs setting for the workpiece with the base paint applied thereon between the first coating zone and the pre-drying zone.

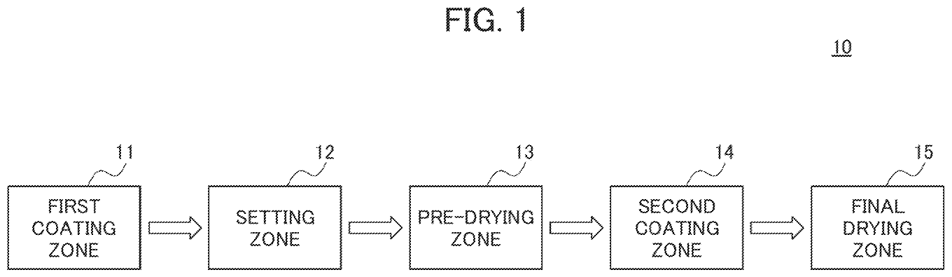

FIG. 1 shows an example of the coating system of the present embodiment.

A coating system 10 includes a first coating zone 11, a setting zone 12, a pre-drying zone 13, a second coating zone 14, and a final drying zone 15. The coating system 10 also includes a transfer unit that transfers a workpiece from the first coating zone 11 to the final drying zone 15. The transfer unit is not particularly limited, and examples thereof include a cart and a belt conveyor.

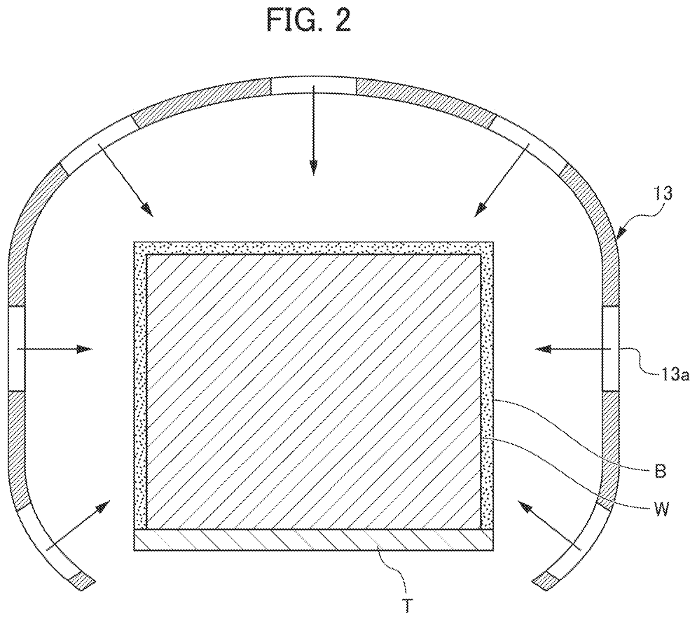

The pre-drying zone 13 has slit-like outlets 13a through which air is blown to an applied base paint B from around a workpiece W placed on a transfer unit T, as shown in FIG. 2. FIG. 2 shows a cross-section of the pre-drying zone 13. The slit-like outlets 13a are provided at regular intervals in the depth direction in FIG. 2. Therefore, unevenness of the air blown to the workpiece W is reduced, so that the residual amount of an organic solvent after pre-drying is evenly distributed.

Although the embodiment of the present invention has been described above, the present invention is not limited to the above-described embodiment, and the above-described embodiment may be appropriately modified within the scope of the gist of the present invention.

### EXAMPLES

Examples of the present invention are described below, but the present invention is not limited thereto.

### Example 1

A thermosetting epoxy resin type cationic electrodeposition paint, “Elecron HG-350E” (manufactured by Kansai Paint Co., Ltd.) was applied on an alloyed hot dip galvanized steel sheet (450 mm×300 mm×0.8 mm) by electrodeposition to have a cured film thickness of 20 μm, and was then heated at 170° C. for 30 minutes to be cured. A test piece was thus obtained.

The test piece was coated by the coating system shown in FIG. 1. Specifically, a first aqueous base paint and a second aqueous base paint were applied on the test piece by spray coating and then pre-dried under the following conditions. The first aqueous base paint is a mixture (mass ratio=10:1) of a main agent containing an aqueous acrylic resin, an aqueous polyester resin, an aqueous urethane resin, an additive, water, and butyl cellsolve, and a curing agent containing an aqueous isocyanate and propylene glycol monomethyl ether acetate, and has a nonvolatile (NV) content of 52 mass %. The second aqueous base paint contains an aqueous acrylic resin, an aqueous polyester resin, blocked isocyanate, a melamine resin, an additive, water, and n-butyl alcohol (V value=49), and has a nonvolatile (NV) content of 20 mass %.
Thickness of dried film of the first aqueous base paint: 25 μm
Thickness of dried film of the second aqueous base paint: 20 μm
Temperature of air blown to substantially the whole area of the applied aqueous base paint: 20° C.
Speed of air blown to substantially the whole area of the applied aqueous base paint: 5 m/s
Time during which air is blown to substantially the whole area of the applied aqueous base paint: 10 minutes
As a result, the coating film after pre-drying had a nonvolatile (NV) content of 92.5 mass %, and no occurrence of unevenness was found.

Next, a solvent-based clear coating was applied onto the pre-dried aqueous base paint under the following conditions and was then finally dried. Here, the solvent-based clear coating is a mixture (mass ratio=5:2) of a main agent containing an acrylic resin, an additive, and an organic solvent, and a curing agent containing an HMDI-based isocyanurate prepolymer and an organic solvent.
Thickness of dried film of clear coating: 60 μm
Baking temperature: 85° C.
Baking time: 20 minutes
As a result, no occurrence of popping was found in the coating film after the final drying, and the color difference was also within the range of no problem.

The above results show that the aqueous base paint was able to be pre-dried without heating, that is, energy consumption was able to be reduced.

### Example 2

The test piece was coated in the same manner as in Example 1 except that the time during which air was blown to substantially the whole area of the applied aqueous base paint was changed to 15 minutes. As a result, the coating film after the pre-drying had a nonvolatile (NV) content of 94.1 mass %, and no occurrence of unevenness was found. Further, no occurrence of popping was found in the coating film after the final drying, and the color difference was also within the range of no problem.

The above results show that the aqueous base paint was able to be pre-dried without heating, that is, energy consumption was able to be reduced.

### EXPLANATION OF REFERENCE NUMERALS

10 coating system
11 first coating zone
12 setting zone
13 pre-drying zone
13a outlet
14 second coating zone
15 final drying zone
B base paint
T transfer unit
W workpiece

What is claimed is:

1. A coating method comprising the steps of:
applying a base paint on a workpiece;
blowing air at 19° C. or higher and 26° C. or lower to substantially a whole area of the applied base paint to pre-dry the base paint;
applying a clear coating on the pre-dried base paint; and
finally drying the workpiece with the clear coating applied thereon.

2. The coating method according to claim 1, wherein the air is blown at a speed of 3 m/s or more and 7 m/s or less, and
a time during which the air is blown to substantially the whole area of the applied base paint is 10 minutes or more and 15 minutes or less.

3. The coating method according to claim 1, wherein the base paint contains an organic solvent with a V value of 49 or more.

4. A coating system comprising:
a first coating zone that applies a base paint on a workpiece;
a pre-drying zone that blows air at 19° C. or higher and 26° C. or lower to substantially a whole area of the applied base paint to pre-dry the base paint;
a second coating zone that applies a clear coating on the pre-dried base paint; and
a final drying zone that finally dries the workpiece with the clear coating applied thereon.

5. The coating system according to claim 4, wherein the pre-drying zone has a slit-like outlet through which the air is blown from around the workpiece to the applied base paint.
